(19) United States
(12) Patent Application Publication
(10) Pub. No.: US 2026/0168571 A1
(43) Pub. Date: Jun. 18, 2026

(54) CONTROL APPARATUS FOR VEHICLE

(71) Applicant: TOYOTA JIDOSHA KABUSHIKI KAISHA, Toyota-shi (JP)

(72) Inventor: Katsuya SASAKI, Nagoya-shi (JP)

(73) Assignee: TOYOTA JIDOSHA KABUSHIKI KAISHA, Toyota-shi (JP)

(21) Appl. No.: 19/414,444

(22) Filed: Dec. 10, 2025

(30) Foreign Application Priority Data
Dec. 12, 2024 (JP) 2024-218186

(51) Int. Cl. F16H 61/12

(52) U.S. Cl. CPC F16H 61/12; F16H 2061/124; F16H 2061/1264

(57) ABSTRACT

A control apparatus for a vehicle that includes (i) an engine, (ii) drive wheels, (iii) a fluid transmission device configured to perform a power transmission for transmitting a power of the engine and (iv) a direct clutch configured to connect between an input member and an output member of the fluid transmission device. When it is determined that there is a possibility of occurrence of a lost drive state of a fluid transmission device, reduction of a power transmission in the fluid transmission is suppressed by switching a direct clutch from its released state to its engaged state upon running start of the vehicle, and an upper limit value of an engine rotational speed is set such that the upper limit value is lower than when it is determined that there is no possibility of the occurrence of the lost drive state.

This application claims priority from Japanese Patent Application No. 2024-218186 filed on Dec. 12, 2024, the disclosure of which is herein incorporated by reference in its entirety.

### FIELD OF THE INVENTION

The present invention relates to a control apparatus for a vehicle equipped with a fluid transmission device with a direct clutch.

### BACKGROUND OF THE INVENTION

There is known a control apparatus for a vehicle that include (i) an engine, (ii) drive wheels, (iii) a fluid transmission device provided in a power transmission path between the engine and the drive wheels and configured to perform a power transmission for transmitting a power of the engine from an input member of the fluid transmission device to an output member of the fluid transmission device and (iv) a direct clutch configured to connect between the input member and the output member of the fluid transmission device. For example, the vehicle control apparatus described in Patent Document 1 is such an apparatus. Patent Document 1 discloses that, while the vehicle is stopped, it is determined that the fluid transmission device is in a lost drive state, when a transmission mechanism provided downstream of the fluid transmission device is in a state in which the power can be transmitted and a rotational speed of the engine is not lower than a reference speed value. Patent Document 1 also discloses that, if it is determined that the fluid transmission device is in the lost drive state, when the vehicle starts to run, the direct clutch is controlled from a released state to an engaged state so as to suppress reduction of performance of the power transmission in the fluid transmission device. The lost drive state occurs when air gets mixed into a fluid used for the power transmission in the fluid transmission device, resulting in the reduction in the performance of the power transmission from the engine to the transmission mechanism, i.e., the reduction in the performance of the power transmission from the input member to the output member.

### PRIOR ART DOCUMENT

### PATENT DOCUMENT

[Patent Document 1]
Japanese Patent Application Laid-Open 2010-7815

### SUMMARY OF THE INVENTION

However, even if the direct clutch is controlled so as to suppress the reduction of the power transmission performance in the fluid transmission device, there is a possibility that a drive torque will be insufficient during a transient period when the reduction of the power transmission performance is being suppressed, namely, during the transient period when the direct clutch is switched to an engaged state. In this instance, if a rotational speed of the engine is increased as a driver of the vehicle increases an accelerator operation amount, there is a risk that it could cause the driver to feel uncomfortable.

The present invention was made against a background of the above circumstances, and its purpose is to provide a vehicle control apparatus that can reduce discomfort felt by the driver when avoiding or suppressing occurrence of a lost drive state.

According to the present invention, there is provided a control apparatus for a vehicle that includes (i) an engine, (ii) drive wheels, (iii) a fluid transmission device provided in a power transmission path between the engine and the drive wheels and configured to perform a power transmission for transmitting a power of the engine from an input member of the fluid transmission device to an output member of the fluid transmission device and (iv) a direct clutch configured to connect between the input member and the output member of the fluid transmission device. The control apparatus includes: (a) a state determiner configured to determine whether there is a possibility of occurrence of a lost drive state in which performance of the power transmission in the fluid transmission device is reduced; (b) a reduction suppressing controller configured, when it is determined that there is the possibility of the occurrence of the lost drive state, to suppress reduction of the performance of the power transmission in the fluid transmission device, by controlling the direct clutch, which is in a released state when the vehicle is stopped, to switch the direct clutch from the released state to an engaged state upon start of running of the vehicle; and (c) a limit value setter configured to set an upper limit value of a rotational speed of the engine, such that the upper limit value is lower when it is determined that there is the possibility of the occurrence of the lost drive state, than when it is determined that there is no possibility of the occurrence of the lost drive state.

In the control apparatus according to the present invention, when it is determined that there is the possibility of the occurrence of the lost drive state, the reduction of the performance of the power transmission in the fluid transmission device is suppressed, by controlling the direct clutch, which is in the released state when the vehicle is stopped, to switch the direct clutch from the released state to the engaged state upon start of running of the vehicle. Thus, when the vehicle starts to running, the occurrence of the lost drive state is avoided or suppressed. Further, the upper limit value of the rotational speed of the engine is set, such that the upper limit value is lower when it is determined that there is the possibility of the occurrence of the lost drive state, than when it is determined that there is no possibility of the occurrence of the lost drive state. Thus, an increase of the engine rotational speed is suppressed during transition of the direct clutch to the engaged state when the lost drive state is avoided or suppressed. Therefore, it is possible to reduce discomfort felt by the driver when the lost drive state is avoided or suppressed.

### BRIEF DESCRIPTION OF THE DRAWINGS

FIG. 1 is a view schematically showing a construction of a vehicle to which the present invention is applied, and also control functions and main parts of a control system for various controls in the vehicle;

FIG. 2 is a view showing, by way of example, setting of a predetermined length of time for determining a duration of a stopped state of the vehicle;

FIG. 3 is a view showing, by way of example, setting of an upper-limit guard value for an engine rotational speed when there is a possibility that a lost drive state could occur; and

FIG. 4 is a flow chart showing main control operations of an electronic control apparatus, namely, a control routine to be executed by the electronic control apparatus, for reducing discomfort felt by a driver of the vehicle when the occurrence of the lost drive state is to be avoided or suppressed.

### DETAILED DESCRIPTION OF PREFERRED EMBODIMENT

Hereinafter, an embodiment of the present invention will be described in detail with reference to the drawings.

### Embodiment

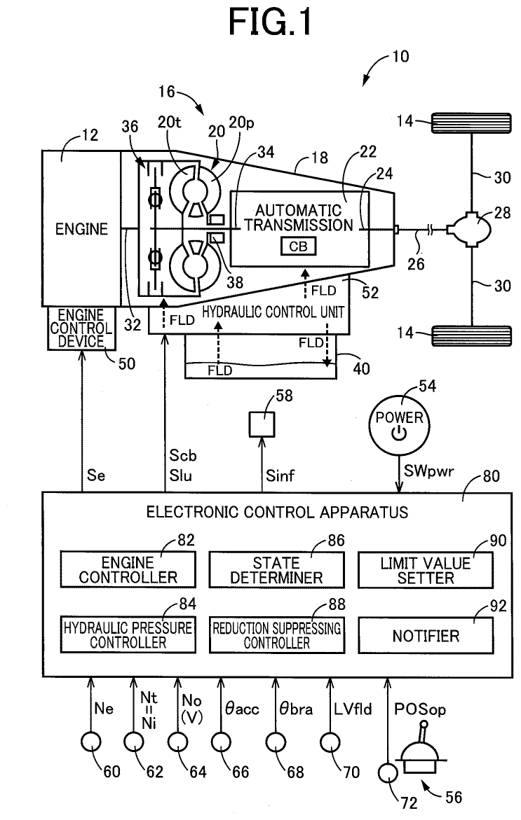

FIG. 1 is a view schematically showing a construction of a vehicle 10 to which the present invention is applied, and also control functions and main parts of a control system for various controls in the vehicle 10. As shown in FIG. 1, the vehicle 10 includes an engine 12, drive wheels 14 and a power transmission device 16 that is provided in a power transmission path between the engine 12 and the drive wheels 14.

The engine 12 is a known internal combustion engine. The engine 12 is equipped with an engine control device 50, which includes an electronic throttle valve, a fuel injection device, an ignition device, etc., and is controlled by an electronic control apparatus 80 (described later), thereby controlling an engine torque Te that is a torque of the engine 12.

The power transmission device 16 includes a torque converter 20 connected to the engine 12, an automatic transmission 22 connected to the torque converter 20 and other components housed within a casing 18 that is a non-rotaty member attached to a body of the vehicle. The power transmission device 16 also includes a propeller shaft 26 connected to a transmission output shaft 24, a differential gear device 28 connected to the propeller shaft 26, and a pair of drive shafts 30 connected to the differential gear device 28. The transmission output shaft 24 is an output rotaty member of the automatic transmission 22. The power transmission device 16 also includes an engine connection shaft 32 that connects between the engine 12 and the torque converter 20.

The torque converter 20 includes a pump impeller 20p connected to the engine connection shaft 32 and a turbine impeller 20t connected to a transmission input shaft 34. The transmission input shaft 34 is an input rotaty member of the automatic transmission 22. The pump impeller 20p is an input member of the torque converter 20, and the turbine impeller 20t is an output member of the torque converter 20. The torque converter 20 corresponds to “fluid transmission device” recited in the appended claims, and is provided in the power transmission path between the engine 12 and the drive wheels 14. The torque converter 20 transmits a power of the engine 12 from the engine connection shaft 32 to the transmission input shaft 34 through a fluid.

The torque converter 20 is equipped with a lock-up clutch 36 that connects between the engine connection shaft 32 and the transmission input shaft 34. The lock-up clutch 36 corresponds to “direct clutch” recited in the appended claims, and connects between the pump impeller 20p and the turbine impeller 20t. The lock-up clutch 36 is, for example, a known hydraulic friction engagement device. An operation state of the lock-up clutch 36 is switched by changing a lock-up torque Tlu, which is a torque capacity of the lock-up clutch 36, by using a lock-up hydraulic pressure PRlu. The lock-up hydraulic pressure PRlu is a hydraulic pressure of a regulated oil FLD that is supplied to the lock-up clutch 36 from a hydraulic control circuit 52 provided in the vehicle 10. The oil FLD is a hydraulic oil used for operating the automatic transmission 22, performing a power transmission for transmitting the power of the engine 12 in the torque converter 20, and switching the operation state of the lock-up clutch 36, for example. The oil FLD corresponds to “fluid” recited in the appended claims.

The operation state of the lock-up clutch 36 includes a released state (also synonymous with a fully released state), a slipped state in which the lock-up clutch 36 is engaged with slippage and an engaged state (also synonymous with a fully engaged state). When the lock-up clutch 36 is in the released state, the torque converter 20 is in a torque converter state in which a torque amplification is achieved. When the lock-up clutch 36 is in the engaged state, the torque converter 20 is in a locked-up state (also called a fully locked-up state) in which the pump impeller 20p and turbine impeller 20t are rotatable together.

The automatic transmission 22 is provided in the power transmission path between the torque converter 20 and the drive wheels 14. The automatic transmission 22 is, for example, a known planetary gear type automatic transmission equipped with engagement devices CB. The engagement devices CB include a plurality of known hydraulic friction engagement devices such as clutches and brakes. The engagement devices CB switch among an engaged state, a slipped state and a released state by changing an engaging torque Tcb, which is a torque capacity of each of the engagement devices CB, using an engaging pressure PRcb. The engaging pressure PRcb is a hydraulic pressure of the regulated oil FLD supplied to each of the engagement devices CB from the hydraulic control circuit 52.

The automatic transmission 22 establishes one of several gear stages with different gear ratios γ(=Ni/No) by engaging one of the engagement devices CB. “Ni” is a rotational speed of the transmission input shaft 34, and is an input rotational speed of the automatic transmission 22, i.e., a transmission-input rotational speed Ni. “No” is a rotational speed of the transmission output shaft 24, and is an output rotational speed of the automatic transmission 22, i.e., a transmission-output rotational speed No. The automatic transmission 22 changes its established gear stage by switching the control state of each of the engagement devices CB by using the electronic control apparatus 80, depending on the driver's accelerator operation, running speed V, etc.

The vehicle 10 is further equipped with a mechanical oil pump 38 connected to the pump impeller 20p, and an oil pan 40 provided in a bottom of the casing 18. The oil pump 38 is driven and rotated by the engine 12, and pumps the oil FLD returned to the oil pan 40 via a strainer (not shown) and supplies it to the hydraulic control circuit 52. The hydraulic control circuit 52 supplies the lock-up oil pressure PRlu and various engaging pressures PRcb, which are regulated based on the oil FLD supplied from the oil pump 38. A portion of the oil FLD supplied to the hydraulic control circuit 52 is supplied to a plurality of lubrication points within the power transmission device 16, for example. The oil FLD discharged from the hydraulic control circuit 52 and the oil FLD supplied to the lubrication points are returned to the oil pan 40 by gravity flow, for example. The oil FLD is pumped up to the oil pan 40, and is circulated in the oil pan 40. The oil pan 40 corresponds to “fluid reservoir” recited in the appended claims.

The vehicle 10 further includes a power switch 54. The power switch 54 is, for example, an automatic reset push button switch. The power switch 54 is a power switch operated by the driver to switch a power-source control state of the vehicle 10. The power-source control state includes, for example, a power ON state, a power partially ON state and a power OFF state. The power ON state is an ignition-on (IG-ON) state in which the engine 12 can be driven. The power partially ON state is an accessory-on (ACC-ON) state in which the engine 12 cannot be driven but some functions not related to the driving of the engine 12 can be performed. The power OFF state is an ignition-off (IG-OFF) state in which the vehicle 10 cannot be driven and some functions not related to the driving of the vehicle 10 cannot be performed, either. For example, in the power OFF state, by pressing the power switch 54, the ignition is switched on and the engine 12, which was previously stopped, is started.

The vehicle 10 is provided with the electronic control apparatus 80 as a controller including a processor that is configured to control the engine 10 and other components of the vehicle 10. The electronic control apparatus 80 includes, for example, a so-called microcomputer equipped with CPU, RAM, ROM, input/output interface, for example. The CPU executes various controls of vehicle 10 by, for example, utilizing the temporary storage function of RAM and performing signal processing in accordance with programs previously stored in ROM. The electronic control apparatus 80 includes various computers for engine control and hydraulic control, for example, as needed. The electronic control apparatus 80 corresponds to “control apparatus” recited in the appended claims.

The electronic control apparatus 80 receives various signals based on the detected values of various sensors provided in the vehicle 10. The various sensors include the power switch 54, an engine speed sensor 60, an input speed sensor 62, an output speed sensor 64, an accelerator-opening degree sensor 66, a brake sensor 68, an oil level sensor 70 and an operating position sensor 72. The various signals include a power switch signal SWpwr, an engine rotational speed Ne, a transmission-input rotational speed Ni, a transmission-output rotational speed No, an accelerator opening degree θacc, a brake operation amount θbra, an oil level LVfld and a selected one of operating positions POSop.

The power switch signal SWpwr is a signal that indicates that the power switch 54 has been pressed. The engine rotational speed Ne is the rotational speed of the engine 12. The transmission-input rotational speed Ni is the same as the turbine rotational speed Nt, which is the rotational speed of the turbine impeller 20t. The transmission-output rotational speed No is the rotational speed that corresponds to a running speed V of the vehicle 10. The accelerator opening degree θacc corresponds to an accelerator operation amount, i.e., an amount of an accelerator operation made by the driver, and indicates a magnitude of the driver's acceleration operation. The brake operation amount θbra is a signal that indicates a state of a brake pedal being operated by the driver to activate wheel brakes, and also a magnitude of the brake pedal operation. The oil level LVfld is a signal that indicates a level or height of the oil FLD reserved in the oil pan 40.

The vehicle 10 further includes a shift device 56 in which one of the plurality of operating positions POSop is selected by the driver. The shift device 56 is a switching device for switching a shift position (also synonymous with a shift range Rsh) of the automatic transmission 22. The POSop operating position is a signal that indicates the selected state of the power transmission state in the automatic transmission 22, and includes, for example, P, R, N, and D operating positions. The shift range Rsh indicates the power transmission state of the automatic transmission 22, and includes, for example, P, R, N, and D positions (also synonymous with the P, R, N, and D ranges).

The P (parking) position indicates the selected state of the P range of the automatic transmission 22, in which the automatic transmission 22 is in a neutral state and the transmission output shaft 24 is mechanically fixed so as to be unrotatable. The neutral state of the automatic transmission 22 is a state in which no gear is formed and the power cannot be transmitted. The R (reverse) position indicates the selected state of the R range of the automatic transmission 22, which enables reverse driving. The R range of the automatic transmission 22 is the reverse driving position of the automatic transmission 22 (which is also synonymous with the reverse driving range). The N (neutral) operating position indicates the selected state of the automatic transmission 22 in which the automatic transmission 22 is in a neutral state. The D (forward drive) position indicates the selected state of the D range of the automatic transmission 22, which executes the automatic gear shift control of the automatic transmission 22 and enables forward drive. The D range of the automatic transmission 22 is a forward drive position (also synonymous with the forward drive range) of the automatic transmission 22. The R and D ranges of the automatic transmission 22 are drive positions (also synonymous with the drive range) that enable the power transmission in the automatic transmission 22. The P and N ranges of the automatic transmission 22 are non-drive positions (also synonymous with the non-drive range) that disable the power transmission in the automatic transmission 22.

The electronic control apparatus 80 outputs various command signals to each device provided in the vehicle 10. The devices are the engine control device 50, the hydraulic control circuit 52 and an information notification device 58, for example. The various command signals are an engine control command signal Se, an engaging pressure control command signal Scb, a lock-up hydraulic control command signal Slu and an information notification control command signal Sinf, for example.

The information notification device 58 is a device that notifies the driver of various information. The information notification device 58 is, for example, a display device such as a monitor, a display and an alarm lamp, and/or a sound output device such as a speaker and a buzzer. The information notification device 58 notifies the driver of, for example, selectable menus, notices, guidance, occurrence of malfunction related to driving and/or degradation of a function related to driving.

The engine control command signal Se is a command signal for controlling the engine 12. The engaging pressure control command signal Scb is a command signal for controlling the engagement devices CB and is a command oil pressure for the engaging pressure PRcb. The lock-up hydraulic control command signal Slu is a command signal for controlling the lock-up clutch 36 and is a command oil pressure for the lock-up oil pressure PRlu. The information notification control command signal Sinf is a command signal for controlling notification of various information to the driver and is content of the notification by the information notification device 58.

The electronic control apparatus 80 includes an engine controller 82, a hydraulic pressure controller 84, a state determiner 86, and a reduction suppressing controller 88 to realize various controls in the vehicle 10.

The engine controller 82 calculates a drive request amount made by the driver to the vehicle 10, for example, by applying the accelerator opening degree θacc and the running speed V to a drive request amount map. The drive request amount map is a relationship for calculating the drive request amount that is determined in advance, for example, experimentally or by design, and stored, i.e., is predetermined. The drive request amount is, for example, a required drive torque Twdem, which is a required value of a drive torque Tw at the drive wheels 14. The engine controller 82 outputs the engine control command signal Se to control the engine 12 so as to obtain the engine torque Te that realizes the required drive torque Twdem.

The engine controller 82 outputs the engine control command signal Se to control the engine 12 such that the engine rotational speed Ne is within a range not exceeding a maximum rotational speed Nemax. For example, when the engine rotational speed Ne is close to the maximum rotational speed Nemax, the engine controller 82 executes a fuel cut control to stop supply of fuel to the engine 12. The maximum rotational speed Nemax is, for example, an upper limit value of the engine rotational speed Ne, which is determined by a predetermined rating of the engine 12, such that the performance of the engine 12 is less likely to be reduced. In other words, the maximum rotational speed Nemax is an upper limit value of the engine rotational speed Ne that defines an operating range of the engine 12. The maximum rotational speed Nemax is, for example, a predetermined upper limit rotational speed Nelim or a permissible maximum rotational speed Nepmt. The predetermined upper limit rotational speed Nelim is, for example, an engine rotational speed that is determined in advance as a rotational speed that must not be exceeded in terms of durability of the engine 12. The maximum permissible rotational speed Nepmt is, for example, the engine rotational speed Ne that is predetermined to be lower than the predetermined upper limit rotational speed Nelim by a margin α. The margin α is, for example, a predetermined allowance to prevent the engine rotational speed Ne from exceeding the predetermined upper limit rotational speed Nelim.

The hydraulic pressure controller 84 determines whether to shift gears in the automatic transmission 22, by using, for example, a predetermined shift map, and outputs the engaging pressure control command signal Scb to supply the engaging torque Tcb that causes the automatic transmission 22 to shift gears based on the results of that shift determination. The shift map is a predetermined relationship that has shift lines on a two-dimensional coordinate system with variables such as the running speed V and the accelerator opening degree θacc, for example, to determine whether to shift the gears in the automatic transmission 22.

The hydraulic pressure controller 84 determines a control region, by using, for example, a predetermined lock-up region diagram, and outputs the lock-up hydraulic control command signal Slu to supply the lock-up hydraulic pressure PRlu that will realize a control state corresponding to the determined control region. The lock-up region diagram is a predetermined relationship on a two-dimensional coordinate system with, for example, the running speed V and the required drive torque Twdem as variables, having a release region corresponding to the released state, a slip region corresponding to the slipped state, and a lock-up region corresponding to the engaged state.

If the oil level LVfld is low when the oil pump 38 pumps up the oil FLD from the oil pan 40, air bubbles are more likely to be formed in the oil FLD. The oil FLD with the air bubbles is circulated through the hydraulic control circuit 52 and flows into, for example, the torque converter 20. When the air bubbles are present in the oil FLD, the power transmission performance in the torque converter 20 is reduced or even stopped. The air bubbles in the oil FLD can cause a lost drive state in the torque converter 20, which reduces the power transmission performance from the engine 12 to the automatic transmission 22, i.e., from the pump impeller 20p to the turbine impeller 20t. If the lost drive state occurs, there is a risk that the vehicle 10 could not start to run quickly when the accelerator is turned on. As a countermeasure to the lost drive state caused by the air bubbles in the oil FLD, namely, as an alternative to the power transmission performance made by the torque converter 20, it is possible to control the lock-up clutch 36, which is in a released state, to switch to an engaged state when the vehicle 10 is to start to run.

The state determiner 86 determines whether or not there is a possibility that the lost drive state could occur. For example, the state determiner 86 determines whether or not the oil level LVfld in the oil pan 40 is equal to or lower than a predetermined level value LVfldf. The predetermined level value LVfldf is, for example, a predetermined threshold value for determining that the oil level LVfld is at a level at which the air bubbles are likely to be formed in the oil FLD. The state determiner 86 also determines whether or not the shift range Rsh of the automatic transmission 22 is a driving range, namely, whether or not the shift position of the automatic transmission is in the drive position. In the driving range, the engaging pressure PRcb must be supplied to engage the engagement devices CB, so that a flow rate of the oil FLD pumped up from the oil pan 40 is increased as compared to the non-driving range, thereby making it more likely that the air bubbles could be form in the oil FLD. The state determiner 86 also determines whether or not the stopped state of the vehicle 10 has continued for a predetermined length of time Tzero or more, i.e., whether or not the predetermined length of time Tzero has elapsed with the running speed V being zero. The predetermined length of time Tzero is a predetermined threshold used to determine whether the vehicle 10 has been stopped in the driving range for a length of time that would cause a large number of air bubbles to be formed in the oil FLD.

The state determiner 86 determines that there is a possibility that lost drive state could occur when determining that the oil level LVfld is equal to or lower than the predetermined level value LVfldf, the shift range Rsh is the driving range, and the vehicle 10 has been stopped for the predetermined length of time Tzero or longer. The state determiner 86 determines that there is not possibility that the lost drive state could not occur when determining that the oil level LVfld is higher than the predetermined level value LVfldf, or the shift range Rsh is the non-driving range, or the vehicle 10 has been stopped for less than the predetermined length of time Tzero.

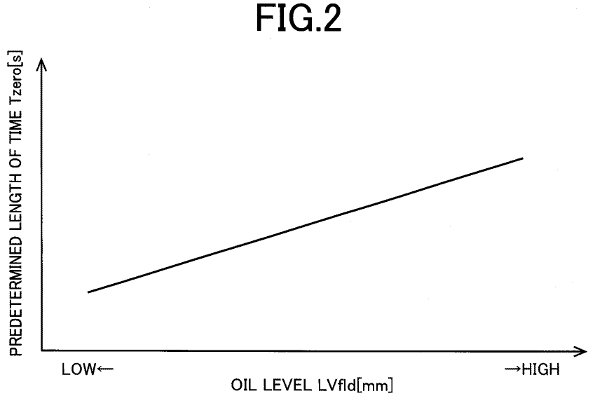

FIG. 2 shows an example of setting of the predetermined length of time Tzero to determine the duration of the stopped state. As shown in FIG. 2, the predetermined length of time Tzero is made shorter as the oil level LVfld is lower, because the lower the oil level LVfld, the more the air bubbles will be generated in the oil FLD even if the stopped state of the vehicle 10 in the driving range is short. Thus, the lower the oil level LVfld, the shorter the predetermined length of time Tzero.

When the engine 12, which has been stopped, is started by operating the power switch 54, the air bubbles are likely to be generated in the oil FLD. The state determiner 86 determines whether the power-source control state is in the ignition-on state (IG-ON). When determining that the power-source control state is in the ignition-on state, the state determiner 86 determines whether there is the possibility of occurrence of the lost drive state.

When the state determiner 86 determines that there is the possibility of occurrence of the lost drive state, the reduction suppressing controller 88 outputs a command Ss to the hydraulic pressure controller 84 so as to control the lock-up clutch 36, which is in the released state when the vehicle 10 stopped, to switch to the engaged state when the vehicle 10 starts to run. By outputting the command Ss to the hydraulic pressure controller 84, the reduction suppressing controller 88 executes a lost-drive resolution control, which suppresses the reduction of the power transmission performance in the torque converter 20. The lost-drive resolution control is a control that enables the vehicle 10 to start to run even if the lost drive state occurs to an extent that the power transmission performance of the torque converter 20 completely fails. In other words, the lost-drive resolution control is a control for avoiding or suppressing the occurrence of the lost drive state.

By the way, even if the lost-drive resolution control is executed when starting the vehicle 10, which can cause the lost drive state, there is a possibility that the drive torque Tw could be insufficient during the transitional period when the lock-up clutch 36 is switched to the engaged state. In this instance, the engine rotational speed Ne could be increased as a result of increase of the accelerator operation amount by the driver, thereby causing the driver to feel uncomfortable. When the lock-up clutch 36 is in the engaged state, the engine rotational speed Ne (=Ni=γ×No) is dependent on the transmission output rotational speed No and gear ratio γ. Therefore, it is desirable to suppress the increase of the engine rotational speed Ne during the transitional period when the lock-up clutch 36 is switched to the engaged state.

To this end, the electronic control apparatus 80 further includes a limit value setter 90. When the state determiner 86 determines that there is the possibility of the occurrence of the lost drive state, the limit value setter 90 makes an upper-limit guard for setting an upper limit value of the engine rotational speed Ne to an upper-limit guard value Negrd. The upper-limit guard value Negrd corresponds to “lower value” recited in the appended claims, and is lower than the above-described maximum rotational speed Nemax. Further, when the state determiner 86 determines that there is the possibility of the occurrence of the lost drive state, the engine controller 82 outputs the engine control command signal Se to control the engine 12 such that the engine rotational speed Ne remains within a range that does not exceed the upper-limit guard value Negrd.

The upper-limit guard value Negrd is a predetermined value that is higher by a margin β than a synchronous rotational speed Nisyc (=γ×No) of the transmission-input rotational speed Ni, which is determined by the transmission-output rotational speed No and the gear ratio γ. The margin β is a predetermined amount of rotation that makes it difficult to feel an increase in engine rotational speed Ne. Alternatively, the upper-limit guard value Negrd is a predetermined constant value that hardly causes the driver to feel the increase of the engine rotational speed Ne. The upper-limit guard value Negrd is also set to a value that prevents the engine 12 from stalling during the transition when the lock-up clutch 36 is switched to the engaged state during execution of the lost-drive resolution control. This reduces the discomfort felt by the driver and also prevents the engine 12 from stalling.

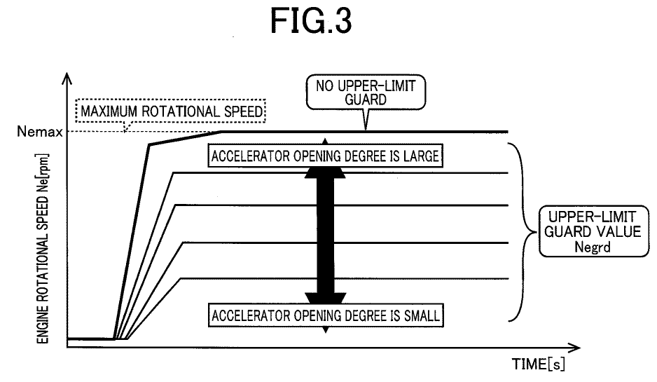

FIG. 3 shows an example of the setting of the upper-limit guard value Negrd for the engine rotational speed Ne when there is the possibility of the occurrence of the lost drive state. As shown in FIG. 3, the upper-limit guard value Negrd is set lower as the accelerator opening degree θacc is smaller, because the more likely the driver will feel uncomfortable the smaller accelerator opening degree θacc even if the engine rotational speed Ne is increased only slightly. For example, as shown in FIG. 3, the limit value setter 90 sets the upper-limit guard value Negrd to a lower value as the accelerator opening degree θacc is smaller. It is noted that, when the upper-limit guard is not made, the upper limit value of the engine rotational speed Ne is set to the maximum rotational speed Nemax.

If the driver anticipates reduction of the acceleration responsiveness in even of the occurrence of the lost drive state occurs, or reduction of the acceleration responsiveness due to setting of the upper-limit guard value of the engine rotational speed Ne in process of the lost-drive resolution control, the driver is less likely to feel uncomfortable. In other words, if the driver is informed that the lost drive state could occur, the driver is less likely to feel uncomfortable.

To this end, the electronic control apparatus 80 further includes a notifier 92. When the state determiner 86 determines that there is the possibility of occurrence of the lost drive state, the notifier 92 outputs the information notification control command signal Sinf to notify the driver that there is the possibility of occurrence of the lost drive state. For example, the notifier 92 displays a message on the information notification device 58, indicating that there is the possibility of occurrence of the lost drive state. Alternatively, the notifier 92 outputs a sound from the information notification device 58 indicating that there is the possibility of occurrence of the lost drive state.

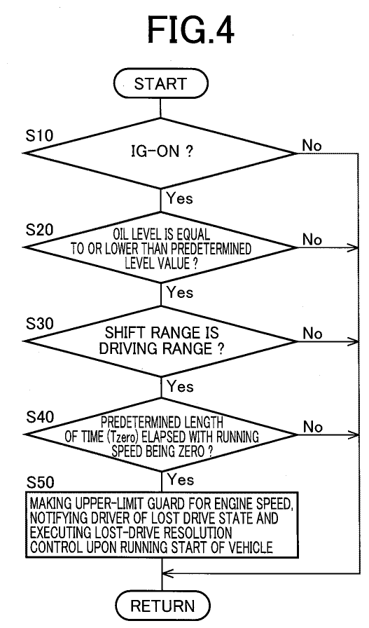

FIG. 4 is a flow chart showing main control operations of the electronic control apparatus 80, namely, a control routine to be executed by the electronic control apparatus 80, for reducing discomfort felt by the driver of the vehicle 10 when the occurrence of the lost drive state is to be avoided or suppressed. This control routine is executed in a repeated manner, for example.

As shown in FIG. 4, the control routine is initiated with step S10 corresponding to function of the state determiner 86, to determine whether the power-source control state is in the ignition-on state (IG-ON). When an affirmative determination is made at step S10, step S20 corresponding to function of the state determiner 86 is implemented to determine whether the oil level LVfld is equal to or lower than the predetermined level value LVfldf. When an affirmative determination is made at step S20, step S30 corresponding to function of the state determiner 86 is implemented to determine whether the shift range Rsh is the driving range. When an affirmative determination is made at step S30, step S40 corresponding to function of the state determiner 86 is implemented to determine whether the running speed V is zero and the predetermined length of time Tzero has elapsed. When an affirmative determination is made at step S40, step S50 corresponding to functions of the limit value setter 90, the notifier 92 and the reduction suppressing controller 88 is implemented to make the upper-limit guard for the engine rotational speed Ne, and also to notify the driver that the lost drive state could occur. Further, at step S50, the lost-drive resolution control is executed when the vehicle 10 is to starts to run. One cycle of execution of the control routine is terminated, after implementation of step S50, or when a negative determination is made at any one of steps S10, S20, S30 and S40.

As described above, in the present embodiment, when it is determined that there is the possibility of the occurrence of the lost drive state, the lost-drive resolution control is executed. Thus, when the vehicle 10 starts to running, the occurrence of the lost drive state is avoided or suppressed. Further, the an upper-limit guard for the engine rotational speed Ne is performed when it is determined that there is the possibility of the occurrence of the lost drive state. Thus, the increase of the engine rotational speed Ne is suppressed during transition of the lock-up clutch 36 to the engaged state when the lost drive state is avoided or suppressed. Therefore, it is possible to reduce discomfort felt by the driver when the lost drive state is avoided or suppressed.

Further, in the present embodiment, the upper-limit guard value Negrd in the upper-limit guard for the engine rotational speed Ne is set to a lower value as the accelerator opening degree θacc is smaller. As a result, the upper-limit guard value Negrd is set in accordance with the accelerator operation made by the driver, thereby appropriately reducing any discomfort felt by the driver.

Further, in the present embodiment, when it is determined that there is the possibility of occurrence of the lost drive stat, the possibility of occurrence of the lost drive state is notified. As a result, even if there is a reduction of the acceleration responsiveness due to the upper-limit guard for the engine rotational speed Ne, or even if there is a reduction of the acceleration responsiveness when the lost drive state occurs, the discomfort felt by the driver can be reduced. In other words, the driver can recognize the situation, and therefore anxiety felt by the driver can be reduced.

Further, in the present embodiment, it is determined that there is the possibility of occurrence of the lost drive state, when three conditions are all satisfied, wherein the three conditions consist of a first condition that the oil level LVfld is equal to or lower than the predetermined level value LVfldf, a second condition that the shift range Rsh is the driving range, and a third condition that the vehicle 10 has been stopped for a predetermined length of time Tzero or longer. Thus, it is possible to accurately determine that there is the possibility of occurrence of the lost drive state, thereby appropriately reducing any discomfort or anxiety felt by the driver.

Further, in the present embodiment, the lower the oil level LVfld is, the shorter the predetermined length of time Tzero is. Thus, the lost-drive resolution control, which is a countermeasure against the lost drive state, can be executed appropriately while minimizing the execution of the lost-drive resolution control.

Although the embodiment of the present invention has been described in detail above with reference to the drawings, the present invention can also be applied to other embodiments.

For example, in the above-described embodiment, step S10 in FIG. 4 may be omitted. Also, the notification of the possibility of occurrence of the lost drive state at step S50 in FIG. 4 may not be made. Even in this case, a certain effect of the present invention can be obtained, that is, reducing the discomfort felt by the driver when avoiding or suppressing the occurrence of the lost drive state.

Further, in the above-described embodiment, a planetary gear type stepped transmission is used as the automatic transmission 22, but the invention is not limited to this detail. For example, the automatic transmission 22 may be a synchronous mesh type parallel two-shaft automatic transmission including a known DCT (Dual Clutch Transmission), or a known belt type continuously variable transmission with a forward/reverse switching device provided in the front or rear stage. Further, instead of the torque converter 20, another fluid transmission device such as a fluid coupling that does not have a torque boosting function may be used. In short, the present invention can be applied to any vehicle equipped with an engine, a fluid transmission device and a direct clutch.

It should be noted that the above is merely one embodiment, and the present invention can be embodied in various forms with various modifications and improvements based on the knowledge of those skilled in the art.

### NOMENCLATURE OF ELEMENTS

10: vehicle
12: engine
14: drive wheel
20: torque converter (fluid transmission device)
20p: pump impeller (input member)
20t: turbine impeller (output member)
22: automatic transmission
36: lock-up clutch (direct clutch)
40: oil pan (fluid reservoir)
80: electronic control apparatus (control apparatus)
86: state determiner
88: reduction suppressing controller
90: limit value setter
92: notifier

FLD: oil (fluid)

What is claimed is:

1. A control apparatus for a vehicle that includes (i) an engine, (ii) drive wheels, (iii) a fluid transmission device provided in a power transmission path between the engine and the drive wheels and configured to perform a power transmission for transmitting a power of the engine from an input member of the fluid transmission device to an output member of the fluid transmission device and (iv) a direct clutch configured to connect between the input member and the output member of the fluid transmission device,
the control apparatus comprising:
a state determiner configured to determine whether there is a possibility of occurrence of a lost drive state in which performance of the power transmission in the fluid transmission device is reduced;
a reduction suppressing controller configured, when it is determined that there is the possibility of the occurrence of the lost drive state, to suppress reduction of the performance of the power transmission in the fluid transmission device, by controlling the direct clutch, which is in a released state when the vehicle is stopped, to switch the direct clutch from the released state to an engaged state upon start of running of the vehicle; and
a limit value setter configured to set an upper limit value of a rotational speed of the engine, such that the upper limit value is lower when it is determined that there is the possibility of the occurrence of the lost drive state, than when it is determined that there is no possibility of the occurrence of the lost drive state.

2. The control apparatus according to claim 1,
wherein the limit value setter is configured to set the upper limit value to a lower value as an accelerator operation amount becomes smaller.

3. The control apparatus according to claim 1, further comprising a notifier configured to notify that there is the possibility of the occurrence of the lost drive state, when it is determined that there is the possibility of the occurrence of the lost drive state.

4. The control apparatus according to claim 1,
wherein the vehicle further includes (v) an automatic transmission provided in the power transmission path between the fluid transmission device and the drive wheels and (vi) a fluid reservoir, such that a fluid used for operation of the automatic transmission and the power transmission performed in the fluid transmission device is pumped from the fluid reservoir and the fluid is circulated in the fluid reservoir, and
wherein the state determiner is configured to determine that there is the possibility of the occurrence of the lost drive state, when a level of the fluid in the fluid reservoir is not higher than a predetermined level value, a shift position of the automatic transmission is in a drive position enabling transmission of the power in the automatic transmission and the vehicle has been stopped for at least a predetermined length of time.

5. The control apparatus according to claim 4,
wherein the predetermined length of time is made shorter as the level of the fluid in the fluid reservoir is lower.

6. The control apparatus according to claim 1,
wherein the limit value setter is configured, when it is determined that there is the possibility of the occurrence of the lost drive state, to set the upper limit value of the rotational speed of the engine, to a lower value lower than a maximum rotational speed that defines an operating range of the engine.
